(19) United States
(12) Patent Application Publication
(10) Pub. No.: US 2024/0171698 A1
(43) Pub. Date: May 23, 2024

(54) VIDEO CAPTURE

(71) Applicant: Mo-Sys Engineering Limited, London (GB)

(72) Inventor: Michael Paul Alexander Geissler, London (GB)

(73) Assignee: Mo-Sys Engineering Limited, London, OT (GB)

(21) Appl. No.: 18/549,074

(22) PCT Filed: Mar. 4, 2022
(86) PCT No.: PCT/GB2022/050585

§ 371 Date: Sep. 5, 2023

(30) Foreign Application Priority Data
Mar. 4, 2021 (GB) 2103059.8
Jul. 7, 2021 (GB) 2109804.1
Oct. 13, 2021 (GB) 2114637.8

(51) Int. Cl. H04N 5/272; G06T 7/73

(52) U.S. Cl. CPC H04N 5/272; G06T 7/74; G06T 2207/30204

(57) ABSTRACT

A back-lit screen comprising: a rigid frame extending around the periphery of the screen and having a front face, the front face having an interior face which defines an opening, and an outer face which defines the exterior contour of the frame transversely to the opening; and a translucent sheet extending across the opening; the frame being configured so that over at least a part of the periphery of the screen the forward-most part of the interior face is coincident with the exterior contour of the frame.

This invention relates to back-lit screens and also to chromakeyed video capture.

Back-lit screens are used for purposes such as exhibition stands. A typical back-lit screen comprises a structural frame with a sheet of translucent material supported by the frame. One or more lamps illuminate the rear of the screen; that is the side opposite the side at which the intended viewer is to be located. Because the sheet material is translucent, and not transparent, light from the lamps passes through the sheet material and is scattered by it so that a viewer at the front of the screen sees the screen as having a somewhat uniform overall luminance. The screen may be of a uniform colour or it may bear messaging. When the screen is acting as a backdrop for an exhibition stand it may bear logos and other promotional words and images.

Sometimes multiple individual back-lit screens are arranged next to each other to form a composite back-lit screen. This may happen when the overall size of the required screen is larger than individual screens that are available or when the screen is required to have a non-planar shape. For example, a composite screen may be composed of three planar walls arranged to form a back-lit bay. FIG. 1 shows a cross-section on a horizontal plane at the meeting point of two individual screens. Each individual screen comprises a frame 1 which supports a translucent sheet 2. Lamps 3 are disposed behind each sheet. A problem with composite screens of this type is that typically the illumination of the composite screen is irregular at the meeting point of the individual screens. The meeting point may be a location where one planar screen is angled relative to an adjacent planar screen, forming a corner. The frame 1 of each screen extends laterally beyond the sheet 2 of the screen as indicated at 4. And there is a region 5 of the frame against which the sheet 2 is tensioned which obstructs light from the respective lamp(s). This results in a region 4 along the meeting point of the individual screens where no light from the lamps 3 passes through the screen. As a result, the overall illumination from the screen to a viewer is non-uniform. Typically, there is a dark stripe or shadow line at the meeting point of the screens. This is unsightly when the back-lit screen is being used for promotional purposes.

When the back-lit screen is being used as a chroma key background, dark stripes of this nature can interfere with the chroma-keying process. For chroma keying, the screen may be illuminated with light of a predetermined and/or uniform colour. The colour may, for example, be green or blue.

There is a need for an improved back-lit screen.

It is known to display a predetermined colour on a screen behind a subject, to capture video of the subject against the screen and to then post-process the captured video to replace regions of the predetermined colour with parts of another video feed. This gives the impression in the output video that the subject is at a location represented in the other video feed. This technique is known as chromakeying. When this is done over a whole image the task of replacing the predetermined colour can be computationally intensive. Also, unwanted artefacts such as reflections or glows of the predetermined colour can be formed on the subject.

There is a need for an improved approach to chromakeying.

According to one aspect there is provided a screen controller for forming an output image feed for display by a screen, the screen controller comprising one or more processors and memory storing program code executable by the processor to cause the processor to: receive an input image feed; receive an indication of a first region of the screen overlain by a subject; determine a border region extending beyond the first region; and form the output image feed so as to comprise the input image feed overlain in the border region by a field of a predetermined colour.

The input image feed may be a video feed. The output image feed may be a video feed.

The program code may be such as to cause the processor to form the output image feed so as to comprise the input image feed overlain in the border region and the first region by a field of the predetermined colour.

The border region may extend fully around the subject where the subject overlays the screen. The subject may overlay the screen from a determined point of view. That may be the point of view of a camera.

The predetermined colour may be a chromakey colour. It may be green or blue, for example.

The program code may be such as to cause the processor to determine the location of the first region in dependence on a received point of view from which the screen is overlain in the first region by the subject.

The program code may be such as to cause the processor to determine the border region so as to subtend an angle of 30 degrees or less from the received point of view.

The first region may be the entire region of the screen overlain by the subject.

According to a second aspect there is provided a method for forming a processed video output, the method comprising: providing a video camera and a screen; determining the location of the video camera relative to the screen; receiving an input image feed; determining a first region of the screen overlain by a subject from the point of view of the camera; determining a border region extending beyond the first region; forming an output image feed so as to comprise the input image feed overlain in the border region by a field of a predetermined colour; and displaying the output image feed on the screen.

The screen may be an LED wall.

The method may further comprise capturing by the camera a video of the subject against the screen; and post-processing the captured video to form an output video by replacing regions of the predetermined colour in the captured video by portions of the input video feed.

The method may comprise post-processing the captured video to form an output video by replacing regions of the predetermined colour in the captured video by portions of the input video feed that were overlain in the border region by the field of the predetermined colour.

The method may comprise forming the output image feed so as to comprise the input image feed overlain in the border region and the first region by a field of the predetermined colour.

The method may comprise determining the first region of the screen by projecting an infra-red beam from the camera towards the screen and detecting that part of the screen shaded from the infra-red beam by the subject.

The method may comprise estimating the location of the camera by reference to reference markers in the environment of the camera.

According to another aspect there is provided a back-lit screen comprising a rigid frame extending around the periphery of the screen and having a front face, the front face having an interior face which defines an opening, and an outer face which defines the exterior contour of the frame transversely to the opening. There is a translucent sheet extending across the opening. The frame is configured so that over at least a part of the periphery of the screen the forward-most part of the interior face is coincident with the exterior contour of the frame.

The translucent sheet may bear on the forward-most part of the frame to extend across the opening.

The translucent sheet may be flexible and may be secured to the frame in a recess on the outer face of the frame.

The frame may comprise a plurality of linear elements joined together to define the opening.

The back-lit screen may comprise an illuminator located behind the sheet for shining light through the sheet.

The illuminator may be carried by the frame.

The illuminator may be elongate and may extend along at least a part of the frame for preferentially illuminating a peripheral portion of the sheet.

The illuminator may be controllable to vary the colour of light emitted therefrom.

There is provided a composite back-lit screen comprising a plurality of individual back-lit screens located adjacent to each other.

The individual back-lit screens may be located adjacent to each other such that a forward-most part of one of the screens is located adjacent a forward-most part of another of the screens.

The individual back-lit screens may be located adjacent to each other such that their respective translucent sheets are coplanar.

The composite back-lit screen may comprise a controller for independently controlling the colour and/or intensity of illuminators located to shine light through respective ones of the individual screens.

The present invention will now be described by way of example with reference to the accompanying drawings.

In the drawings:

FIG. 1 is a cross-section through a prior art back-lit screen.

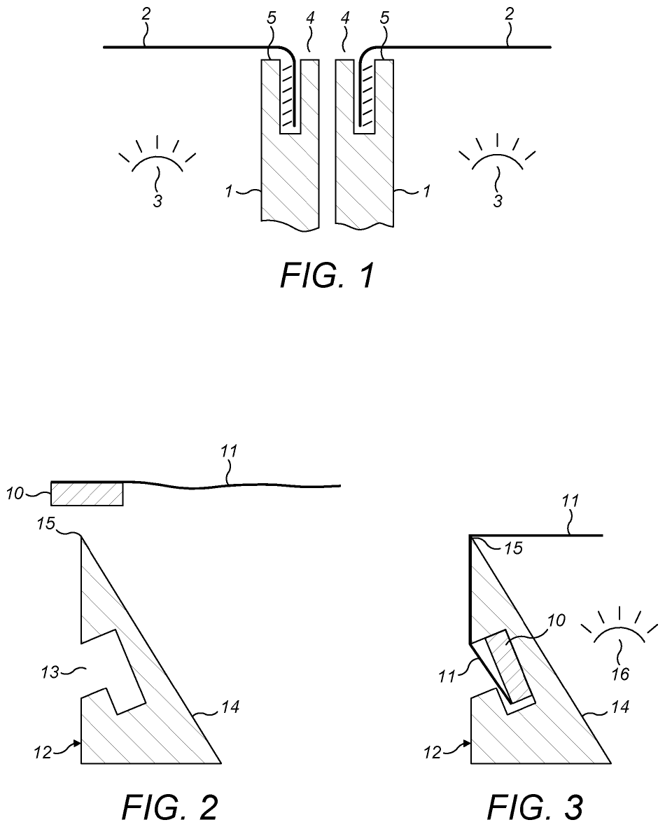

FIG. 2 is a cross-section through components of a back-lit screen.

FIG. 3 shows the components of FIG. 3 assembled.

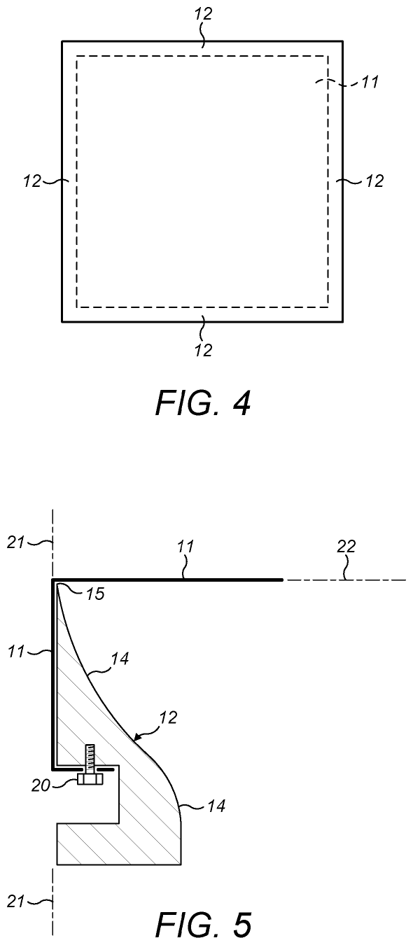

FIG. 4 is a front view of a screen formed from the components of FIG. 2.

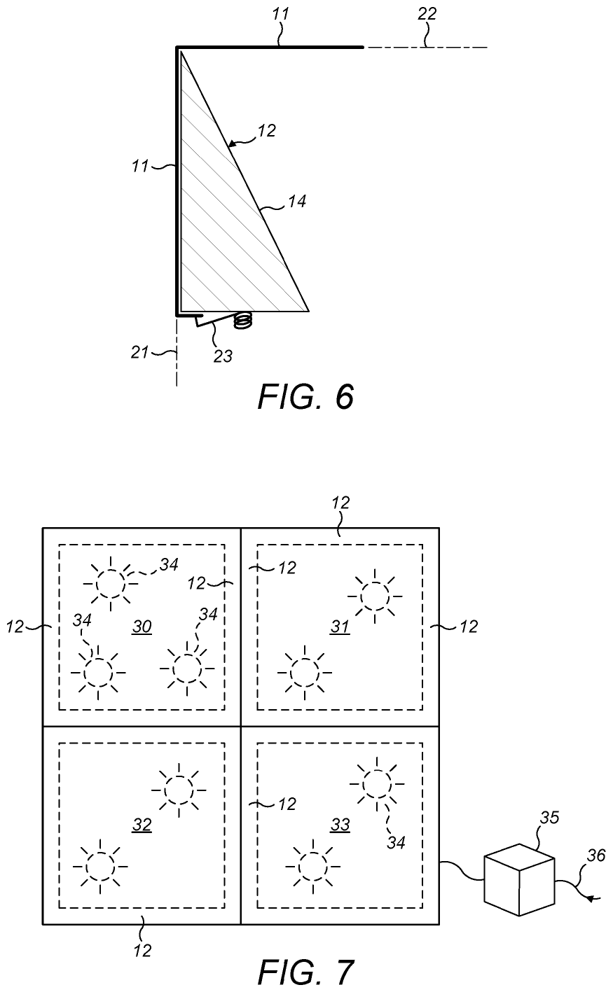

FIGS. 5 and 6 show alternative mechanisms for attaching a sheet to a frame.

FIG. 7 shows a composite back-lit screen.

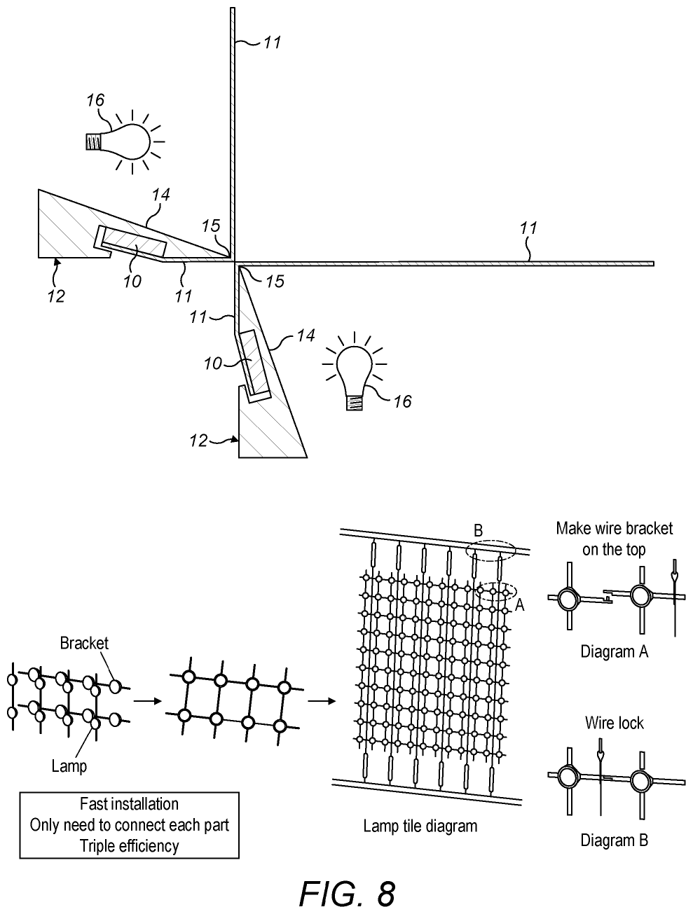

FIG. 8 shows two screens arranged adjacent each other in a non-coplanar configuration.

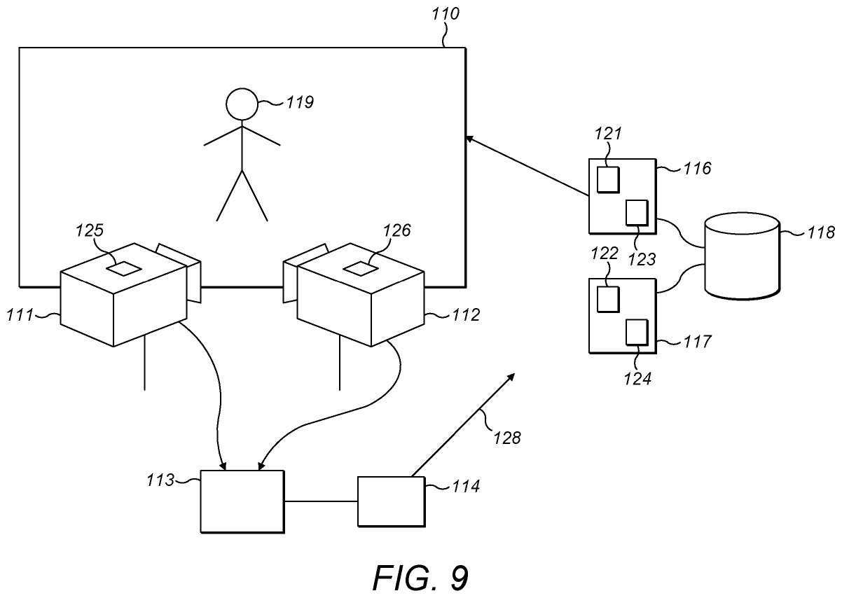

FIG. 9 shows apparatus for capturing chromakeyed video

In the present document the term “back-lit” screen refers to a screen having a frame supporting a translucent sheet irrespective of whether that screen is presently being back-lit.

FIG. 2 shows components for a back-lit screen. The components comprise a screen element and a frame element. The screen element comprises a translucent sheet 11. Only part of the sheet is shown in FIG. 2. At the edges of the sheet are one or more mounting blocks 10 which are attached to the sheet, e.g., by adhesive or mechanical grippers. The mounting block(s) is/are rigid or semi-rigid. It/they may, for example, be polymer block(s) or strip(s). The sheet is flexible. The sheet is translucent and hence not transparent. The sheet is capable of diffusing light passing through it. The sheet may be elastic so that it can be stretched into a taut configuration. This can help to make it planar in the resulting screen.

The frame element comprises a rigid structure 12. Structure 12 extends out of the plane of FIG. 2 to form a linear or curved side of a frame, as illustrated in FIG. 4. Multiple such structures can be attached together, e.g., by corner blocks or fishplates, to form a multi-sided frame, again as shown in FIG. 4. The frame structure 12 has an interior surface 14 which is to face the interior of the frame when assembled. The interior surface is angled so that the frame structure tapers to a point 15 at its end that is to face the front of the frame when assembled. On the exterior surface of the frame structure is a recess 13. The recess 13 is sized to receive the mounting block(s) of the screen element.

FIG. 3 shows the components of FIG. 2 assembled. The mounting block(s) is/are inserted in the recess 13 on the exterior surface of the frame structure 12. This anchor the edge of the translucent sheet 11 to the frame structure. The sheet 11 extends from the mounting block(s) around the pointed tip 15 of the frame structure. From there it extends across the frame to another piece of frame structure, as shown in FIG. 4.

One or more illuminator lamps 16 are located behind the sheet, so as to shine light through the sheet. Because the frame structure tapers to a point at its forward-most tip, light from the illuminator lamp(s) can reach substantially the entire area of the sheet that is exposed at the front of the screen. This can avoid a dark line appearing at the periphery of the screen.

The sheet 11 could be mounted to the frame structure 12 in another way. For example, the mounting blocks could be bolted to the external surface of the frame structure. However, it is preferred that the mounting blocks are mounted to the frame structure such that they are inboard of the periphery of the frame structure when viewed perpendicular to the major plane of the installed sheet. A consequence of that can be that multiple frames of this type can be arranged adjacent to each other with substantially no dark line at the interface between them. This can result in a substantially seamless appearance to a composite back-lit screen or wall formed of multiple individual framed screens.

As shown in FIG. 4, the frame of the screen may be formed from multiple (in this case four) linear rigid elements of frame structure 12. The forward-most parts (15) of the frame support the sheet 11 as it extends across the opening.

FIGS. 5 and 6 illustrate other examples of how the sheet 11 may be attached to the frame structure. In the example of FIG. 5 the sheet is attached by bolts 20 which pass through eyes in the sheet into threaded holes in the frame structure 12. In FIG. 6 the sheet is attached by self-gripping spring clips 23 on the rear surface of the frame structure. In each case, the forward tip 15 of the frame structure is located so that it is coincident with the periphery 21 of the frame structure when viewed perpendicular to the major plane 22 of the sheet. This means that substantially the entirety of the sheet that forms the forward surface of the screen can be illuminated from behind the sheet.

Any suitable number of illuminators may be provided behind the sheet. Conveniently, the sheet is arranged to be illuminated with a uniform light flux, so that it appears to have the same brightness at all points across its forward face. To achieve this, it may be advantageous to mount one or more illuminators on the interior face 14 of the frame and/or to provide one or more illuminators that selectively illuminate the periphery of the forward face of the sheet. In one example, a row of lamps may be provided along the length of each side of the frame. Where multiple illuminators are provided, there may be a control system, such as one or more dimmers, arranged for altering their relative intensity so as to balance the optical flux across the forward face of the screen.

The interior face of the frame structure may be tinted to adjust its reflectivity. For example it may be painted black, white or grey. This may help to make the light distribution even at the periphery of the sheet.

The or each illuminator may, for example, be an LED illuminator. It may have a constant emission colour or its emission colour may be variable. The or each illuminator may comprise multiple sub-illuminators (e.g. red, green and blue LEDs) which can be controlled in combination to yield a desired emission colour.

FIG. 7 shows a composite screen comprising multiple individual screens 30-33 disposed side-by-side in an array. FIG. 7 shows the composite screen as viewed from the front. Each individual screen is provided with respective illuminators 34 for shining through the translucent sheet of that screen. A controller 35 is arranged for controlling the illuminators. The controller 35 is responsive to an input 36 for programming the controller 35 to use a certain illumination sequence or to command the controller in real time, e.g., from a lighting control desk. The controller can control the intensity of the back-lighting of each individual screen independently of the others. The controller can also control the colour of the back-lighting of each individual screen independently of the others. This set-up can provide advantages when the composite screen is being used to illuminate a filming set. The illumination provided by the screen can be adapted to simulate light in a setting that is being replicated on the filming set. For example, if on the filming set a cloud is supposed to have passed across the sun, the intensity of back-lighting of one or more upper ones of the individual screens can be reduced. Or if on the filming set a campfire is being simulated, the intensity of one or more lower ones of the individual screens can be increased and their illumination can be made to flicker yellow and red. A system of this type can also be used to provide a background of a constant colour for chroma key filming.

The screen can be lit from behind. In one arrangement, the lighting of the screen from behind may be uniform. That may allow chroma keying to be performed anywhere over the screen. However, if the colour chosen for chroma keying is an obtrusive colour, this may result in light from parts of the screen that are to the side of a subject such as an actor illuminating the sides of the subject. Illuminations and reflections of the chroma keying colour can cause a glow around the sides of the subject in the chroma keying colour. This interferes with the distinction between the subject and the background which gets keyed out in processing. This results in the edges of the subject being misinterpreted as background and disappearing in processing, as a computer cannot distinguish between the background and the coloured glow around the subject. This effect is called green spill, as green is the most commonly used background in chroma keying. One approach to reduce the effects of green spill, and to provide other affects, is for the screen to be illuminated non-uniformly. Some options for this will now be discussed.

In a first arrangement, a redirectable illuminator is located behind the screen. It may, for example be one or more luminaires on one or more pan/tilt heads. The direction of each luminaire may be controlled manually or by motors. One or more such luminaire are arranged to play onto the rear of the subject talent/object so as to illuminate a region that—from the view of a camera—extends peripherally around the profile of the subject. Regions of the screen further from the subject may be not illuminated from the rear, or may be illuminated with less intensity and/or in a different colour from that with which the peripheral region around the subject is illuminated. The peripheral region may, for example extend less than 5 degrees, less than 10 degrees or less than 30 degrees from the profile of the subject as viewed by the camera. This can result in a reduced level of side-illumination of the subject. Instead of one or more redirectable luminaire, multiple luminaire arranged to illuminate in fixed directions may be turned on and off at appropriate times to provide a similar effect. Different luminaire may illuminate the subject as it moves around in front of the screen so that the glow (or reflections/illumination) of the chroma keyed colour on the edges of the subject is reduced equally regardless of where the subject stands. The colour of the light which illuminates the periphery of the subject may be the same colour as the digital post-processed background. This makes it easier for the edges of the subject to be integrated into the later background and produces a more natural processed image.

Instead of a backlit screen, the screen could be an illuminating wall. That is a wall that comprises a planar array of illuminators such as LEDs. The illuminators of the wall may be selectively turned on or off to illuminate only a peripheral region around a subject of the type described above.

In more detail, there may be a wall provided with internal illuminators in the plane of the wall. It may, for example be an LED wall comprising a matrix of LEDs. Such walls are known for displaying an image behind a subject. This approach may be used to reduce the need for post-processing. When a wall of this general type is used for rear or side illumination of a subject, some factors may be noted.

1. The rear or side illumination need not be at high resolution. Instead of a pixel pitch of approximately 1 mm, which may be chosen for an LED wall, a large pixel pitch may be selected in the present application. For example, the pixel pitch may be 5 mm or higher, 10 mm or higher or 20 mm or higher. This can reduce the cost of the screen.

2. The region that is illuminated may be selected to be (a) just behind and in the periphery of a subject, as viewed from a camera (for, e.g., chroma keying) or (b) to the side of a subject and optionally outside the frustum of a camera (so as to apply an illumination effect to the subject). The rest of the screen outside of these regions may be the colour of the later digitally processed background so as to reduce the amount of the screen in the chroma keyed colour.

3. When only a region behind and in the periphery of a subject is being illuminated, that region may be selected, and the display wall controlled, automatically or manually. For automatic control, a controller may analyse the output of the camera, and determine where in the image illumination from the wall is not detected. That region may be taken to represent a region of the field of view that is occupied by the subject. Then the controller may control the wall so that only that occupied region and its periphery are illuminated. The outer boundary of the periphery may be, for example, 30 cm or less or 1m or less from the occupied region. The occupied region may change from time to time as an actor moves. The controller may repeatedly detect the occupied region and control the wall accordingly. Difference keying may be used to detect where in an image captured by the camera the subject is.

4. A diffuser such as a roughened sheet of glass or polymer or a gauze sheet may be disposed in front of the screen. This can help to disguise the edges between individual pixels of the screen, which may be especially useful when the LED wall is of relatively low resolution.

Thus, a subject may be in front of a screen and video of the subject against a backdrop of the screen may be being recorded by a camera. The screen may be controlled to display a field of a chromakey colour in the immediate penumbra of the subject as seen from the point of view or frustrum of the camera. Outside that penumbra the screen may be controlled to display a picture. Compared to a conventional approach in which the entire backdrop displays the chromakey colour, this approach can reduce the complexity of replacing the chromakeyed colour in a final output video since the replacement only needs to be done in the immediate penumbra of the subject. It can also reduce the incidence of unwanted reflections or glows of the chromakey colour on the subject. The penumbra where the chromakey colour is displayed may be referred to as a dilation of the subject.

The chromakey colour may be any predetermined colour that is identifiable by a chromakey postprocessor to replace that colour with a desired picture. Conveniently it may be a green or blue colour. The chromakey processor may replace the chromakey colour with images that match the picture being shown from time to time on the remainder of the screen. To achieve this, a common still picture or video feed may be used as source for both a controller that controls the display on the screen and the chromakey processor.

The picture displayed on the screen may be a constant still picture or it may be a video that changes over time. The video may comprise a series of frames. The screen could be a projection screen (a front or back projection screen) or a light emitting wall such as an LED wall. A light emitting wall comprises light emitters such as LEDs. The light emitters are configured in an array, for example with an average pitch over the area of the wall of less than 10 mm or less than 5 mm. The light emitters may emit in different colours. The light emitters may be capable of displaying a picture on the wall. The subject could be animate or inanimate; it could be one or more humans, animals and/or objects.

The width of the penumbra or border around the subject where the chromacolour field is to be displayed may be selected depending on the expected rate of movement of the subject and the processing capabilities of the chromakey processor. For example, it may be between 1 and 10 degrees, or between 1 and 20 degrees or between 1 and 30 degrees of arc from the boundary of the subject (preferably the entire boundary of the subject as it overlaps the screen) as viewed from the camera's point of view or frustrum. It may be less than 30 degrees or less than 20 degrees or less than 10 degrees of arc from the boundary of the subject (preferably the entire boundary of the subject as it overlaps the screen) as viewed from the camera's point of view or frustrum

There are various ways to estimate the location of the subject relative to the screen and the camera in order to determine where to display the chromakey penumbra. The location of the camera can be estimated using wheel trackers, ultrawide broadband location systems or using a system such as Startracker available from Mo-Sys Engineering Limited which determines the position of the camera be identifying environmentally fixed markers. The location of the screen can be measured and stored in a control system. If the location of the camera or the screen is known, the location of the other can be estimated by performing geometric analysis on the image of the screen as captured by the camera. The distance of the screen from the camera can be estimated from the size of a picture or part of a picture on the screen as viewed from the camera and the relative attitude of the camera and the screen can be determined from the distortion of the picture or part picture as viewed by the camera. The location of the subject can be determined in any of the following ways, which are merely examples.

1. By comparing an image captured by the camera with the image that the screen has been controlled to display, that part of the displayed image that has been occluded by the subject can be identified. Then a penumbra can be displayed around that part.

2. By performing difference keying between successive frames captured by the camera the part of the captured image that contains the subject can be identified as the subject moves. That part may then be time averaged to estimate the total zone occupied by the subject.

3. The camera or another item of equipment may be provided with a depth sensor such as a radar or lidar sensor. The depth sensor is directed towards the screen. A processor can identify the subject in the data generated by the depth sensor since it will be at a closer depth than the screen. From this the location of the subject can be determined.

4. Stereo cameras could be directed at the screen. The subject could be detected from comparison of the images generated by the cameras, for example as having a greater positional difference in the images than does the backdrop as a result of its being closer to the cameras than the screen. The camera capturing the video could itself be one of the pair of stereo cameras. The other of the stereo cameras could be a camera dedicated for that purpose or it could be another video camera that can also be used to capture output video of the subject.

5. The primary camera or another item of equipment could be provided with an infra-red emitter. Another camera could capture an infra-red image of the screen, conveniently from an oblique angle. The subject can be expected to cast an infra-red shadow on the screen. That shadow can be detected by the other camera, and from that the location of the subject over the screen from the point of view of the primary camera. Conveniently the infra-red emitter is carried with the primary camera so that the shadow is cast from the point of view of the primary camera. Thus, a further camera, for example an infrared camera, can be associated with the camera capturing (e.g.) actors in front of the screen, such that the actor(s) would appear as a shadow within the image captured by the infrared camera. The primary camera (i.e the camera doing the filming) may have an IR light source mounted on it so that it casts a shadow on the LED wall, this shadow being detected by a separate IR camera having a fixed location and which is trained on the LED wall

The locations of secondary cameras described above can be estimated in similar ways to the primary camera.

Conveniently the chromakey colour is displayed behind the subject as well as in the penumbra.

A processing device receives information as available relating to the factors discussed above, for example the location of one or more cameras, the location of the screen, the images captured by the primary camera, any IR shadow end so on. Using that information it employs one of the techniques described above or another technique to estimate where on the screen the chromakey colour should be displayed so that it appears in the penumbra of the subject and preferably also behind the subject in the frustrum of the camera. The processing device also receives a still or motion picture feed. That feed may be held in a data store local to the processing device or at a remote location. The processing device may comprise one or more processors and memory storing in a non-transient form code executable by the processor(s) to cause the processing device to perform its functions. The processing device may be in a single location or distributed over multiple locations. The processing device forms an output stream to be displayed on the screen. That output stream comprises the input stream overlain by the chromakey colour in the selected regions so that from the point of view of the camera the chromakey colour appears in the penumbra of the subject an optionally behind the subject but elsewhere on the screen, around the chromakey colour region on at least some sides thereof, parts of the input feed are shown. The processing device may apply a geometric transformation to the input feed so that it appears correct from the point of view of the camera when the input feed is shown on the screen.

The same processing device or another processing device receives the output stream from the camera comprising a video of the subject against the backdrop of the screen. This processing device acts as a post-processor, to replace the chromakey colour in the captured video with suitable alternative image and thereby form an output video stream. The alternative image can be derived from the same input feed as is passed to the previously described processing device. The post-processor selects such parts of that feed, synchronised to the captured video, to replace the chromakey colour regions and thereby restore the input feed in the chromacolour regions. This results in an output feed that corresponds to a timeslice of the input feed overlain by the subject with no chromakey region visible.

FIG. 9 shows a system for this. An LED wall or screen 110 is controlled by data processing device 116. It has a processor 121 and a memory 123. A primary camera 112 captures video of the subject 119 against screen 110. Camera 112 carries an IR emitter 126. Am IR camera 111 spaced from the camera 112 captures an image of the IR beam against the screen so as to identify where the IR shadow of the subject is on the screen. Data from the cameras is captured by collectors 113 and 114 and passed to a second processing device 117 and also to processing device 116 down line 128. Processing device 117 comprises a processor 122 and a memory 124. It performs the post-processing of the video. Processing devices 116 and 117 receive a video stream from data store 118. Processing device 117 uses this to fill in the chromakeyed parts of the video. Processing device 116 uses it together with the information derived from camera 111 to determine the location of the subject against the screen, estimate a border around the subject, replace that border with the chromakey colour and form an output signal to drive the LED wall. Camera 111 and/or camera 112 may carry a Startracker location system e.g. as shown at 125.

In another arrangement, one or more illuminators located so as to illuminate the rear of the screen may be used to provide illumination effects. For example, one or more illuminators illuminating a subset of the area of the screen may be configured to illuminate the rear of the screen with red or yellow light so as to give the impression of a fire illuminating the rear and/or side of a subject.

FIG. 8 shows the interface between two individual screens of the type discussed above. The tips 15 of the screens can be located adjacent to each other. This can result in there being substantially no dark line at the interface between the adjoining screens. The major planes of the adjoining screens may be coincident, as in the example of FIG. 7, or angled with respect to each other, as in the example of FIG. 8. This can allow non-planar back-lit screens with a substantial absence of shadow lines to be created. The mutually angled screens may, for example, form a two- or three-sided bay in front of which a performer can be located.

The frame structure 12 may be formed in any convenient way. For example, it may be formed of aluminium extrusion. The frame structure may have a constant cross-sectional shape along its length.

The sheet may be flexible or rigid. It may, for example be a fabric or polymer sheet or a ground or etched glass sheet.

The applicant hereby discloses in isolation each individual feature described herein and any combination of two or more such features, to the extent that such features or combinations are capable of being carried out based on the present specification as a whole in the light of the common general knowledge of a person skilled in the art, irrespective of whether such features or combinations of features solve any problems disclosed herein, and without limitation to the scope of the claims. The applicant indicates that aspects of the present invention may consist of any such individual feature or combination of features. In view of the foregoing description it will be evident to a person skilled in the art that various modifications may be made within the scope of the invention.

1. A screen controller for forming an output image feed for display by a screen, the screen controller comprising one or more processors and memory storing program code executable by the processor to cause the processor to:
receive an input image feed;
receive an indication of a first region of the screen overlain by a subject;
determine a border region extending beyond the first region; and
form the output image feed so as to comprise the input image feed overlain in the border region by a field of a predetermined colour.

2. A screen controller as claimed in claim 1, wherein the input image feed is a video feed and the output image feed is a video feed.

3. A screen controller as claimed in claim 1, wherein the program code is such as to cause the processor to form the output image feed so as to comprise the input image feed overlain in the border region and the first region by a field of the predetermined colour.

4. A screen controller as claimed in claim 1, wherein the predetermined colour is a chromakey colour.

5. A screen controller as claimed in claim 1, wherein the program code is such as to cause the processor to determine the location of the first region in dependence on a received point of view from which the screen is overlain in the first region by the subject.

6. A screen controller as claimed in claim 5, wherein the program code is such as to cause the processor to determine the border region so as to subtend an angle of 30 degrees or less from the received point of view.

7. A screen controller as claimed in claim 1, wherein the first region is the entire region of the screen overlain by the subject.

8. A method for forming a processed video output, the method comprising:
providing a video camera and a screen;
determining the location of the video camera relative to the screen;
receiving an input image feed;
determining a first region of the screen overlain by a subject from the point of view of the camera;
determining a border region extending beyond the first region;
forming an output image feed so as to comprise the input image feed overlain in the border region by a field of a predetermined colour; and
displaying the output image feed on the screen.

9. A method as claimed in claim 8, wherein the screen is an LED wall.

10. A method as claimed in claim 8, further comprising:
capturing by the camera a video of the subject against the screen; and
post-processing the captured video to form an output video by replacing regions of the predetermined colour in the captured video by portions of the input video feed.

11. A method as claimed in claim 10, wherein the method comprises post-processing the captured video to form an output video by replacing regions of the predetermined colour in the captured video by portions of the input video feed that were overlain in the border region by the field of the predetermined colour.

12. A method as claimed in claim 8, comprising forming the output image feed so as to comprise the input image feed overlain in the border region and the first region by a field of the predetermined colour.

13. A method as claimed in claim 8, comprising determining the first region of the screen by projecting an infra-red beam from the camera towards the screen and detecting that part of the screen shaded from the infra-red beam by the subject.

14. A method as claimed in claim 8, comprising estimating the location of the camera by reference to reference markers in the environment of the camera.

15. A back-lit screen comprising:
a rigid frame extending around the periphery of the screen and having a front face, the front face having an interior face which defines an opening, and an outer face which defines the exterior contour of the frame transversely to the opening; and
a translucent sheet extending across the opening;
the frame being configured so that over at least a part of the periphery of the screen the forward-most part of the interior face is coincident with the exterior contour of the frame.
